(19) United States
(12) Patent Application Publication
(10) Pub. No.: US 2016/0141928 A1
(43) Pub. Date: May 19, 2016

(54) ROTOR STRUCTURE OF INTERIOR-PERMANENT-MAGNET MOTOR

(71) Applicant: HIWIN MIKROSYSTEM CORP., Taichung City (TW)

(72) Inventors: Ming-Chih LAI, TAICHUNG CITY (TW); Chia-Hsiang LIEN, TAICHUNG CITY (TW)

(21) Appl. No.: 14/541,058

(22) Filed: Nov. 13, 2014

(51) Int. Cl. H02K 1/27

(52) U.S. Cl. CPC H02K 1/2773

(57) ABSTRACT

A rotor structure of interior-permanent-magnet motor includes an iron core member and multiple permanent magnets embedded in the iron core member in the form of a spoke. One end of each magnet near the curvature center of the iron core member is positioned in the space of a corresponding end socket. The space of the end socket restricts the path of the magnetic lines of the magnet and concentrates the magnetic lines to increase the magnetic flux density and enhance the counter potential, whereby the thrust is increased.

### BACKGROUND OF THE INVENTION

1. Field of the Invention

The present invention relates generally to a motor, and more particularly to a rotor structure of interior-permanent-magnet motor.

2. Description of the Related Art

A conventional permanent-magnet motor is generally referred to a motor in which the mechanical commutation units such as carbon brush and commutator of DC motor are replaced with semiconductor switch. The permanent-magnet motors can be classified on the basis of the counter potential wave form. Also, the permanent-magnet motors can be classified into surface-mounted type, interior type and embedded type according to the form of the space in which the permanent magnets are disposed on the surface of the rotor or embedded in the rotor. With respect to the surface-mounted type permanent-magnet motor, the magnets are adhered to the surface of the rotor to achieve larger magnetic flux density. However, in this type of permanent-magnet motor, the magnets can be hardly securely located and are likely to detach from the rotor in high-speed operation. Therefore, the technique for adhering the magnets to the surface of the rotor needs to be improved.

With respect to the interior type and embedded type of permanent-magnet motors, the magnets are embedded in the rotor, whereby the iron core of the rotor surrounds the magnets. Such motor is suitable for high-speed operation. In the interior-permanent-magnet motor, the permanent magnets are embedded in the rotor to concentrate the magnetic flux. The magnetic flux of the magnets on two sides converges to extrude out of the polar face. With respect to a common rotor that has magnetic flux on only one single face, the magnetic flux density of air gap of such type of motor is even over the magnetic beam density of the magnets. Also, the magnetic island area of the rotor is increased so that the inductance difference of d-q axis is enlarged. Therefore, such type of permanent-magnet motor has higher magnetic resistance torque and is more suitable for wide-range operation speed.

The material of the iron core of the rotor, in which the magnets are embedded, is generally characterized by high permeability to reduce the magnetic resistance in the magnetic path. However, in order to avoid magnetic short-circuit, FIG. 1 shows a rotor, which is composed of permeable material and non-permeable material. The local section 1a made of non-permeable material is positioned at two lengthwise ends of the rectangular magnet 1b so as to avoid magnetic short-circuit.

Furthermore, FIG. 2 shows a conventional standard interior-permanent-magnet motor. In order to facilitate the manufacturing and processing of the rotor, the magnets 2a are received in the sockets 2c of the rotor 2b. The capacity of the socket 2c is larger than the volume of the magnet 2a received in the socket 2c. A gap 2d is formed between the socket 2c and the outer circumference of the rotor 2b. Accordingly, the distribution of the magnetic flux density can be adjusted by the magnetic resistance of the gap 2d.

The above conventional technique utilizes the space to form the magnetic resistance area. Also, FIGS. 3 and 4 show another conventional motor rotor structure, in which a gap is formed between the magnetic members and the inner circumference of the rotor. One end of each magnet 3a is adjacent to two shielding spaces 3b, 3c. Alternatively, FIG. 5 shows another conventional motor rotor structure, in which a gap is formed between the magnetic members and the inner circumference of the rotor. A larger socket 4a is formed between the ends of the adjacency magnets 4b.

It can be known from FIGS. 1 to 5 that no matter whether the space is utilized to change the configuration of the rotor or a part of the rotor is made of non-permeable material, the conventional techniques are used to control the magnetic flux density and make the magnetic lines more concentrated so as to more efficiently interlink with the windings of the stator. In addition, by means of restricting the area of the magnetic line path, the cogging torque can be reduced. Although many similar conventional techniques have been disclosed, there are still many items that need to be improved.

### SUMMARY OF THE INVENTION

It is therefore a primary object of the present invention to provide a rotor structure of interior-permanent-magnet motor, which is able to further increase the magnetic flux density and concentrate the magnetic lines so as to increase the thrust of the motor.

To achieve the above and other objects, the rotor structure of interior-permanent-magnet motor of the present invention includes an iron core member and multiple permanent magnets embedded in the iron core member in the form of a spoke. One end of each magnet near the curvature center of the iron core member is positioned in the space of a corresponding end socket. The space of the end socket restricts the path of the magnetic lines of the magnet and concentrates the magnetic lines to increase the magnetic flux density and enhance the counter potential, whereby the thrust is increased.

The rotor structure of interior-permanent-magnet motor includes: an iron core member having a curvature center; multiple insertion sockets radially inward extending from outer circumference of the iron core member by a predetermined depth, the insertion sockets being arranged at equal angular intervals; multiple end sockets respectively formed on the iron core member in adjacency to rear ends of the insertion sockets in communication with the corresponding insertion sockets, each end socket having a width larger than a width of the insertion socket in communication with the end socket; and multiple magnetic members each having a predetermined fixed length, the magnetic members being respectively inserted in the insertion sockets, one lengthwise end of the magnetic member extending from the insertion socket into the adjacent end socket by a predetermined extending length, the relationship between the above components meeting the following formulas:

0<b/a≦½; formula 1:

0<c<e; formula 2:

and

e=2d+c, formula 3:

wherein:

a is the fixed length of the magnetic member;

b is the extending length of the magnetic member;

c is the interval between two adjacent end sockets;

d is the distance between a sidewall of the end socket and a sidewall of the insertion socket in communication with the end socket; and

e is the interval between two adjacent insertion sockets.

In the above rotor structure of interior-permanent-magnet motor, the depth of the end socket is larger than the extending length of the magnetic member.

In the above rotor structure of interior-permanent-magnet motor, each end socket is formed with two symmetrical shoulder sections on two sides of the insertion socket in communication with the end socket, each shoulder section having a width equal to d.

In the above rotor structure of interior-permanent-magnet motor, the other lengthwise end of the magnetic member is sunk in the insertion socket by a predetermined depth.

The above rotor structure of interior-permanent-magnet motor further includes multiple locating bodies respectively protruding from bottom walls of the corresponding end sockets by a predetermined height. The other lengthwise end of the magnetic member abuts against the top end of the corresponding locating body to locate the magnetic member. Accordingly, the assembling process of the magnetic member is facilitated.

In the above rotor structure of interior-permanent-magnet motor, the height of the locating body is equal to the difference between the depth of the corresponding end socket and the extending length of the magnetic member.

The present invention can be best understood through the following description and accompanying drawings, wherein:

### BRIEF DESCRIPTION OF THE DRAWINGS

FIG. 1 is a sectional view of a conventional motor rotor structure, in which the iron core is composed of different materials;

FIG. 2 is a sectional view of another conventional motor rotor structure, in which a gap is formed between the magnetic members and the outer circumference of the rotor;

FIG. 3 is a sectional view of still another conventional motor rotor structure, in which a gap is formed between the magnetic members and the inner circumference of the rotor;

FIG. 4 is a sectional view according to FIG. 3, showing the magnetic lines of the conventional motor rotor structure;

FIG. 5 is a sectional view of still another conventional motor rotor structure, in which a gap is formed between the magnetic members and the inner circumference of the rotor;

FIG. 6 is a sectional view of a first embodiment of the present invention;

FIG. 7 is an enlarged view of circled area A of FIG. 6;

FIG. 8 is a sectional view of the first embodiment of the present invention, showing the magnetic lines thereof; and

FIG. 9 is a sectional view of a part of a second embodiment of the present invention.

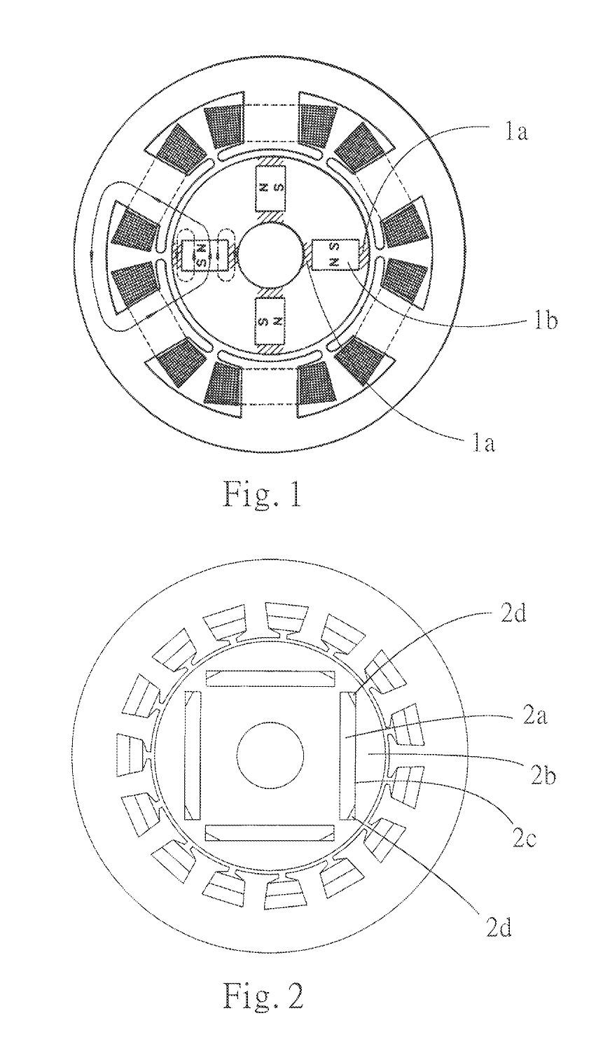

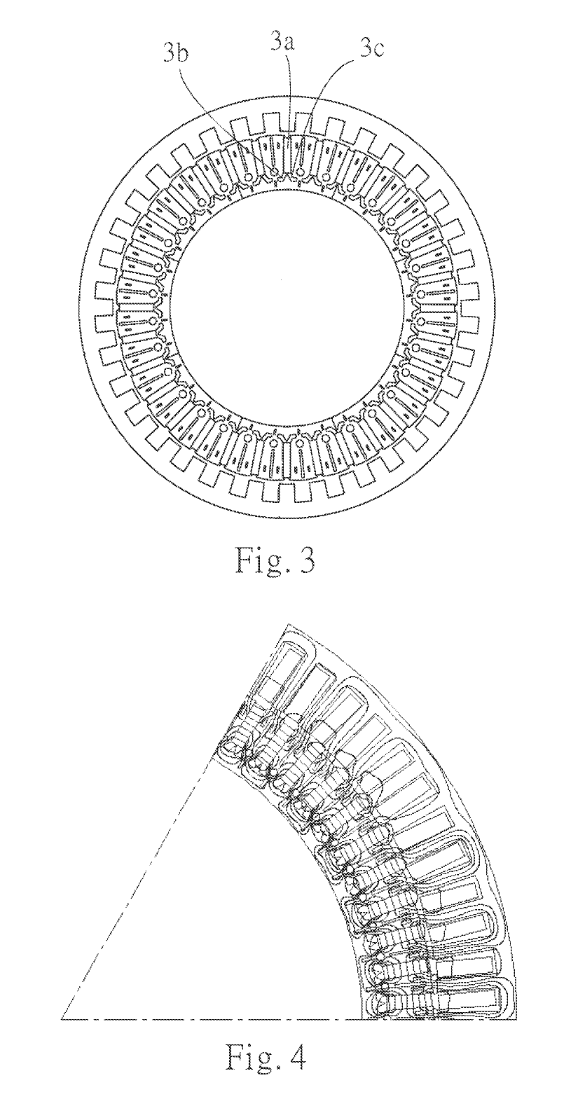

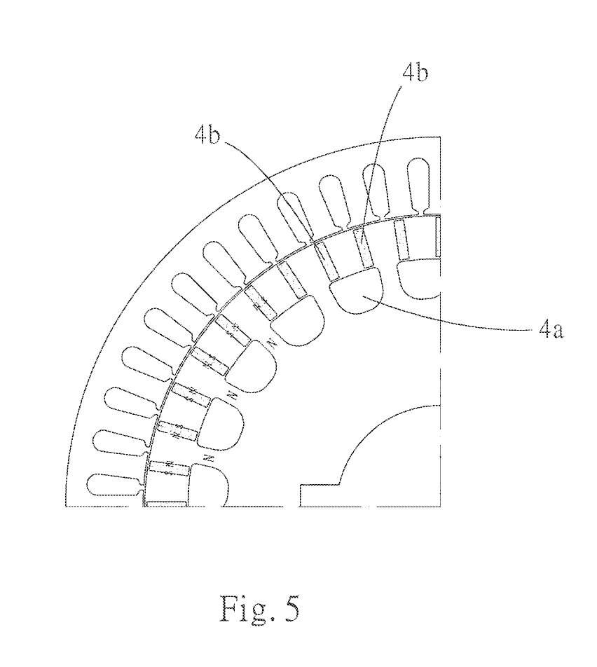

### DETAILED DESCRIPTION OF THE PREFERRED EMBODIMENTS

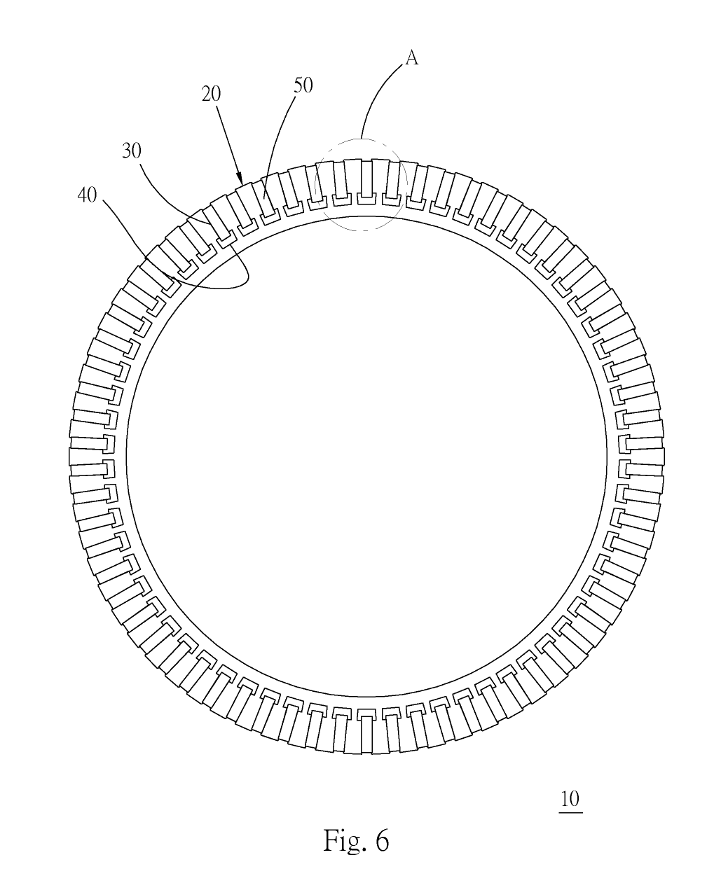

Please refer to FIGS. 6 to 8. According to a first embodiment, the rotor structure 10 of interior-permanent-magnet motor of the present invention is substantially similar to the spoke structure of the conventional interior-permanent-magnet motor, including an iron core member 20, multiple insertion sockets 30, multiple end sockets 40 and multiple magnetic members 50.

The iron core member 20 is made of a permeable material such as silicon steel sheet by the conventional technique. The iron core member 20 has an annular form with a curvature center and axially extends by a certain length.

Each insertion socket 30 is a straight socket with a certain width. The insertion sockets 30 radially inward extend from outer circumference of the iron core member 20 by a certain depth. The insertion sockets 30 are arranged at equal angular intervals. The depth of the insertion socket 30 is smaller than the thickness of the iron core member 20 between the inner and outer circumferences. Accordingly, the iron core member 20 still has a complete inner ring section 21 with a certain thickness along the inner circumference. This ensures the path of magnetic lines. The opening 31 of the insertion socket 30 is positioned on the outer circumference of the iron core member 20. The opening 31 has a width smaller than the width of the insertion socket 30.

Each end socket 40 is an equilateral trapezoidal space formed on the inner ring section 21 of the iron core member 20. The end sockets 40 are respectively adjacent to the rear ends of the insertion sockets 30 in communication with the insertion sockets 30. The end socket 40 has a width larger than the width of the insertion socket 30 in adjacency to and in communication with the end socket 40. The end socket 40 and the adjacent insertion socket 30 have corresponding sizes meet a specific condition as described hereinafter.

Each magnetic member 50 is a plate body with a certain thickness. The magnetic member 50 has a fixed length. The magnetic members 50 are respectively inserted in the corresponding insertion sockets 30. One lengthwise end of the magnetic member 50 is sunk in the opening 31 of the insertion socket 30 and spaced from the opening 30 by a certain distance. The other lengthwise end of the magnetic member 50 extends from the insertion socket 30 into the adjacent end socket 40 by a certain extending length.

The end socket 40 is formed in accordance with the following formulas:

0<b/a½; formula 1:

0<c<e; formula 2:

and

e=2d+c, formula 3:

wherein:

a is the fixed length of the magnetic member 50;

b is the extending length of the magnetic member 50;

c is the interval between two adjacent end sockets 40;

d is the distance between a sidewall 41 of the end socket 40 and a sidewall 32 of the insertion socket 30 in communication with the end socket 40; and

e is the interval between two adjacent insertion sockets 30.

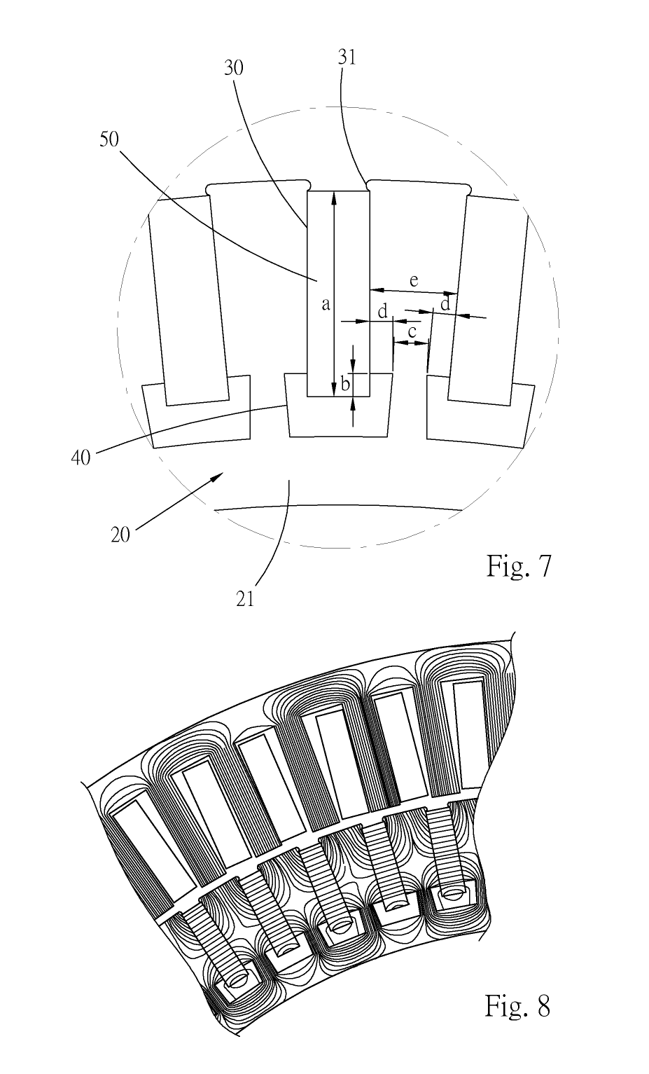

According to the above arrangement, in the rotor structure 10 of interior-permanent-magnet motor of the present invention, the end sockets 40 provide suitable magnetic resistance against the magnetic poles of the other lengthwise ends of the magnetic members 50 as shown in FIG. 8. Therefore, the magnetic lines of the magnetic members 50 can be concentrated onto a restricted section between two corresponding adjacent end sockets 40 of the iron core member 20. In this case, the magnetic flux density of the iron core member 20 can be increased to enhance the counter potential. Accordingly, the rotor structure 10 of interior-permanent-magnet motor of the present invention can achieve better thrust output.

Moreover, the magnetic members 50 are held and located in the insertion sockets 30 with smaller openings. Therefore, in operation of the rotor, the magnetic members 50 are prevented from detaching out of the insertion sockets 30 due to centrifugal force. It should be noted that in order to provide more secure fixing effect, a non-permeable material such as epoxy can be filled in the spaces of the end sockets 40 and the spaces of the openings 31 of the insertion sockets 30 by a conventional fixing technique to provide better fixing effect.

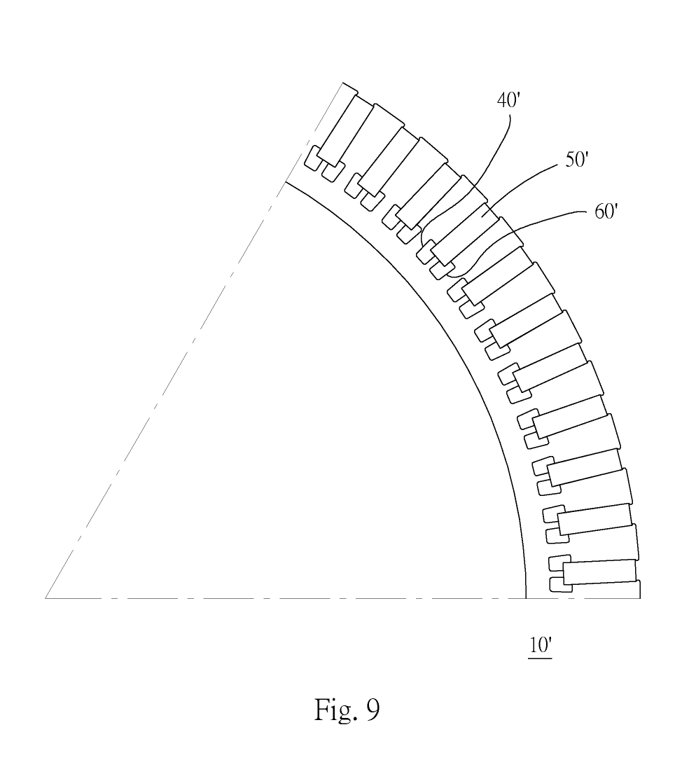

In addition, to achieve the main effect of the present invention, it must be ensured that the other lengthwise end of the magnetic member 50 extends into the interior space of the corresponding end socket 40. In order to facilitate the manufacturing and assembling processes of the present invention, FIG. 9 shows a second embodiment of the rotor structure 10′ of interior-permanent-magnet motor of the present invention. In comparison with the first embodiment, the second embodiment further includes multiple locating bodies 60′ respectively protruding from the bottom walls of the corresponding end sockets 40′. The height of the locating body 60′ is equal to the difference between the depth of the corresponding end socket 40′ and the extending length of the magnetic member 50′. Accordingly, when the magnetic member 50′ is inserted into the corresponding insertion socket 30′, the other lengthwise end of the magnetic member 50′ abuts against the top end of the corresponding locating body 60′ to locate the magnetic member 50′. In this case, the assembling process of the magnetic member 50′ is facilitated.

The above embodiments are only used to illustrate the present invention, not intended to limit the scope thereof. Many modifications of the above embodiments can be made without departing from the spirit of the present invention.

What is claimed is:

1. A rotor structure of interior-permanent-magnet motor, comprising:
an iron core member having a curvature center;
multiple insertion sockets radially inward extending from outer circumference of the iron core member by a predetermined depth, the insertion sockets being arranged at equal angular intervals;
multiple end sockets respectively formed on the iron core member in adjacency to rear ends of the insertion sockets in communication with the corresponding insertion sockets, each end socket having a width larger than a width of the insertion socket in communication with the end socket; and
multiple magnetic members each having a predetermined fixed length, the magnetic members being respectively inserted in the insertion sockets, one lengthwise end of the magnetic member extending from the insertion socket into the adjacent end socket by a predetermined extending length, the relationship between the above components meeting the following formulas:
0<b/a½; formula 1:
0<c<e; formula 2:
and
e=2d+c, formula 3:
wherein:
a is the fixed length of the magnetic member;
b is the extending length of the magnetic member;
c is the interval between two adjacent end sockets;
d is the distance between a sidewall of the end socket and a sidewall of the insertion socket in communication with the end socket; and
e is the interval between two adjacent insertion sockets.

2. The rotor structure of interior-permanent-magnet motor as claimed in claim 1, wherein the depth of the end socket is larger than the extending length of the magnetic member.

3. The rotor structure of interior-permanent-magnet motor as claimed in claim 1, further comprising multiple locating bodies respectively protruding from bottom walls of the corresponding end sockets by a predetermined height.

4. The rotor structure of interior-permanent-magnet motor as claimed in claim 3, wherein the height of the locating body is equal to the difference between the depth of the corresponding end socket and the extending length of the magnetic member.

5. The rotor structure of interior-permanent-magnet motor as claimed in claim 1, wherein the other lengthwise end of the magnetic member is sunk in the insertion socket by a predetermined depth.

6. The rotor structure of interior-permanent-magnet motor as claimed in claim 1, wherein each end socket is formed with two symmetrical shoulder sections on two sides of the insertion socket in communication with the end socket, each shoulder section having a width equal to d.
